(19) United States
(12) Patent Application Publication
(10) Pub. No.: US 2008/0260343 A1
(43) Pub. Date: Oct. 23, 2008

(54) Slotted Ribbon Splitting Tool

(75) Inventors: Justin Elisha Quinn, Newton, NC (US); Tim Davis, Hickory, NC (US); Daniel Miller, Hickory, NC (US)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: DRAKA COMTEQ B.V., Amsterdam (NL)

(21) Appl. No.: 12/105,578

(22) Filed: Apr. 18, 2008

Related U.S. Application Data
(60) Provisional application No. 60/913,161, filed on Apr. 20, 2007.

(51) Int. Cl. G02B 6/00; B21F 13/00; B26D 3/00; B23P 11/00

(52) U.S. Cl. 385/134; 30/90.4; 83/13; 29/428

(57) ABSTRACT

Disclosed is a tool and related method for splitting optical fiber ribbons into smaller optical fiber ribbon sub-units.

### CROSS-REFERENCE TO PRIORITY APPLICATION

This application hereby claims the benefit of Provisional Patent Application Ser. No. 60/913,161, for Slotted Ribbon Splitting Tool (filed Apr. 20, 2007) via 35 U.S.C. §119. Provisional Patent Application Ser. No. 60/913,161 is hereby incorporated by reference in its entirety.

### FIELD OF THE INVENTION

The invention relates to a tool for splitting optical fiber ribbons into smaller units. The invention further relates to mechanically separating optical fiber ribbons into fiber ribbon sub-units of a lesser fiber count.

### BACKGROUND

Optical fiber cables are used to transmit information including telephone signals, television signals, data signals, and Internet communication. These optical fiber cables typically include numerous optical fibers that are joined into one or more distinct fiber ribbons. Optical fiber ribbons are commercially available in various fiber counts (e.g., 4, 6, 8, 12, 16, 24, or 36 fibers or more).

It is often necessary to separate optical fiber ribbons into sub-units for repairing, re-routing, or splicing operations. The optical fiber ribbons must be sufficiently robust to pass recognized industry specifications (e.g., Telcordia GR-20-CORE or ICEA-640) and to maintain integrity (e.g., not split apart) during cable manufacturing. Consequently, a tool is typically required to mechanically split the ribbons into sub-units while maintaining the structural integrity of the sub-units.

Several ribbon-splitting tools are known in the art. For instance, U.S. Pat. Nos. 5,685,945 and 5,944,949 disclose method and apparatus for mechanically splitting optical fiber ribbons from optical fiber ribbon assemblies. Similarly, U.S. Pat. No. 6,909,832 discloses an optical fiber ribbon-splitting tool that longitudinally splits an optical fiber ribbon that is positioned sideways (i.e., flat) in a guide groove.

The ribbon-splitting tools disclosed in the aforementioned patents have complicated designs requiring multiple precision-machined components and, therefore, are relatively expensive.

Accordingly, there is a need for an uncomplicated, cost-effective device for splitting one or more optical fiber ribbons into ribbon sub-units.

### SUMMARY OF THE INVENTION

Accordingly, in one aspect, the invention embraces a user-friendly tool for splitting optical fiber ribbons into fiber ribbon sub-units of a particular fiber count.

In another aspect, the invention embraces an easy method for splitting optical fiber ribbons into one or more fiber ribbon sub-units.

In yet another aspect, the invention embraces a cost-effective method of making the optical fiber ribbon-splitting tool.

The foregoing, as well as other characteristics and advantages of the invention and the manner in which the same are accomplished, is further specified within the following detailed description and its accompanying drawings.

### BRIEF DESCRIPTION OF THE DRAWINGS

FIG. 1 depicts an exemplary slotted ribbon-splitting tool according to the present invention.

FIG. 2 illustrates an optical fiber ribbon longitudinally and vertically positioned within the ribbon-splitting tool for separation into ribbon sub-units.

FIG. 3 depicts another exemplary slotted ribbon-splitting tool according to the present invention illustrating distinct slots on different planar sections of the tool housing.

FIG. 4 depicts yet another exemplary slotted ribbon-splitting tool according to the present invention illustrating multiple distinct slots on one planar section of the tool housing.

FIG. 5 depicts an exemplary 12-fiber mono-unit optical fiber ribbon.

FIGS. 6 and 7 depict exemplary 24-fiber multi-unit optical fiber ribbons with two 12-fiber ribbon sub-units.

### DETAILED DESCRIPTION

An optical fiber ribbon includes multiple color-coded, optical fibers secured together by a coating (e.g., an acrylic coating).

As will be understood by those having ordinary skill in the art, an optical fiber ribbon can be a mono-unit fiber ribbon or a multi-unit fiber ribbon (i.e., two or more mono-units fused together). For instance, two 12-fiber mono-unit ribbons may be fused to form a 24-fiber multi-unit ribbon, or three 12-fiber mono-unit ribbons may be fused to form a 36-fiber multi-unit ribbon. It is sometimes necessary to split optical fiber ribbons and to thereby separate the optical fibers into ribbon sub-units. As noted, this typically requires the use of a ribbon-splitting tool.

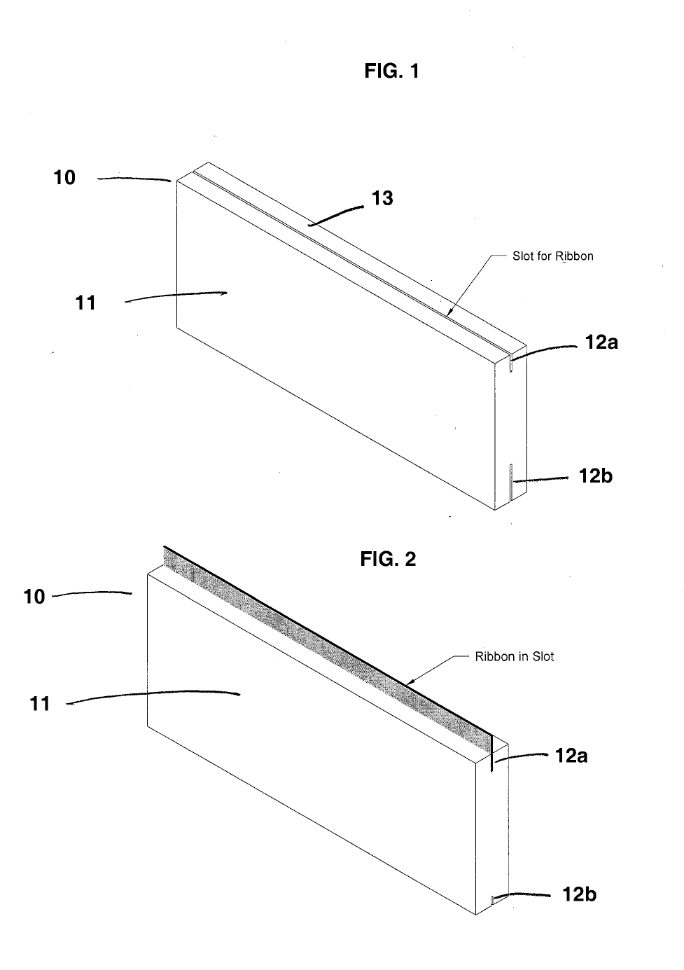

Accordingly, the improved ribbon-splitting tool according to the present invention facilitates the separation of optical fiber ribbons into ribbon sub-units by employing one or more precise ribbon slots. As depicted in FIG. 1, the ribbon-splitting tool 10 includes a tool housing 11 into which two precision ribbon slots 12a and 12b are machined. The narrow ribbon slots 12a and 12b are precisely formed into respective planar sections 13 and 15 of the tool housing 11. Such precision machining can be achieved (i.e., tight tolerances), for instance, using an electrical discharge machine (EDM).

The tool housing 11 is typically a durable material, such as anodized metal (e.g., anodized aluminum) or stainless steel. Other acceptable materials of construction (e.g., ceramics) will be known to those having ordinary skill in the art.

To facilitate the separation of an optical fiber ribbon into fiber ribbon sub-units having different fiber counts (e.g., a 12-fiber sub-unit and 10-fiber sub-unit), ribbon slots 12a and 12b can be cut to differing depths. To ensure that an optical fiber ribbon is adequately seated within the ribbon slot 12a, the ribbon slot 12a generally has a depth that is greater than two times (2×) the average fiber diameter possessed by the optical fiber ribbon (e.g., about 500 microns).

In practice, and as depicted in FIG. 2, part of an optical fiber ribbon is vertically seated into a narrow, longitudinal ribbon slot 12a. As discussed herein, the ribbon slot 12a is machined to comport with the specifications of a particular optical fiber ribbon (i.e., achieve separation between particular optical fibers in the ribbon). After the optical fiber ribbon is partially seated in the ribbon slot 12a, the user simply bends (i.e., flexes) the unseated portion of the optical fiber ribbon, thereby causing the optical fiber ribbon to split along its length. To ensure that sufficient bending leverage is applied to the optical fiber ribbon, the unseated portion of the optical fiber ribbon should generally include four or more fibers.

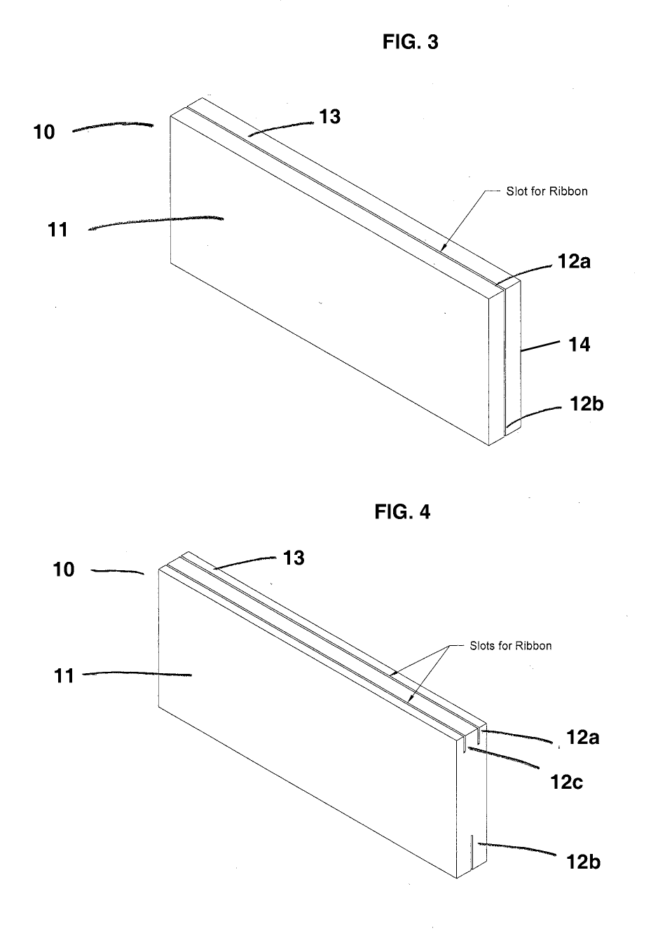

In another exemplary embodiment, the optical ribbon-splitting tool of the present invention may include discrete precision ribbon slots 12a and 12b in two or more different planar sections of the tool housing 11. See FIG. 3 (illustrating ribbon slots in adjacent planar sections 13 and 14). These ribbon slots 12a and 12b are typically machined at different depths.

In yet another exemplary embodiment, the optical ribbon-splitting tool of the present invention may include two or more precision ribbon slots 12a and 12c in one planar section 13 of the tool housing 11. See FIG. 4. These ribbon slots 12a and 12c are likewise typically machined at different depths.

As noted, ribbon slots 12a-c that are formed at differing depths facilitate the separation of an optical fiber ribbon into fiber ribbon sub-units having different fiber counts (e.g., a 12-fiber sub-unit and 6-fiber sub-unit). Accordingly, it is both efficient and convenient to include multiple slots 12a-c in the tool housing 11.

Those having ordinary skill in the art will appreciate that, to ensure separation between particular adjacent fibers (e.g., between the sixth and seventh optical fibers in a 12-fiber optical fiber ribbon), the ribbon slots must be formed at a precise depth. Consequently, each ribbon slot must be manufactured in accordance with the product specifications (e.g., fiber count, fiber dimensions, and ribbon coating) for a particular optical fiber ribbon.

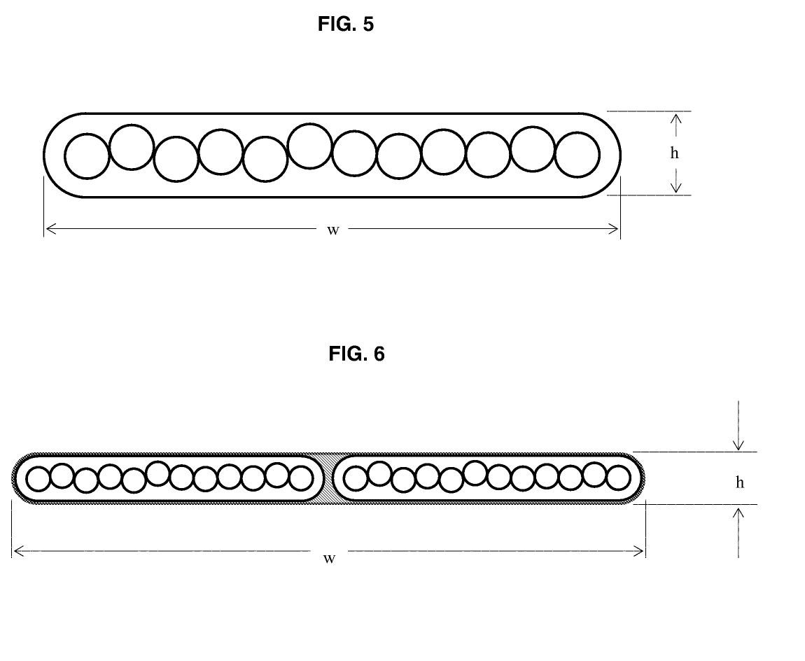

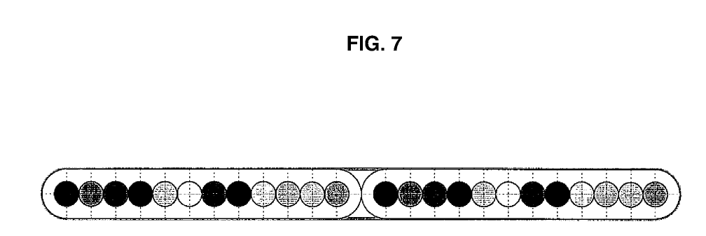

FIG. 5 schematically illustrates an exemplary 12-fiber mono-unit optical fiber ribbon, and FIGS. 6 and 7 schematically illustrate exemplary 24-fiber multi-unit optical fiber ribbons with two 12-fiber ribbon sub-units.

By way of example, an exemplary optical fiber ribbon (available from Draka Comteq) is a 24-fiber multi-unit fiber ribbon formed from two fused 12-fiber mono-unit ribbons. This multi-unit fiber ribbon has a cross-sectional height (i.e., thickness) of approximately 325 microns (+/−35 microns) and a cross-sectional width of approximately 6055 microns (+/−170 microns). (Each optical fiber has a finished diameter of about 240-245 microns.)

Thus, to split this 24-fiber multi-unit fiber ribbon into its constituent 12-fiber mono-unit ribbons requires a ribbon-splitting tool having a ribbon slot that is approximately 3025-3030 microns deep and sufficiently wide to accommodate the height of the 24-fiber ribbon, including its tolerance of 35 microns (i.e., 360 microns or more).

In this example, the 24-fiber multi-unit ribbon has a relatively larger separation between its two 12-fiber sub-units than will a 24-fiber mono-unit ribbon that is formed in a single step (i.e., by joining 24 distinct optical fibers).

Accordingly, the depth of the tool's ribbon slot is configured to divide the 24-fiber multi-unit ribbon at its seam to yield its two constituent 12-fiber ribbons. Those having ordinary skill in the art will appreciate that dividing a 24-fiber mono-unit ribbon into two 12-fiber ribbon sub-units will likely require a ribbon slot of a slightly lesser depth.

Those having ordinary skill in the art will further appreciate that the coating on an optical fiber ribbon creates a “hinge” adjacent to each extreme optical fiber (i.e., the two outermost fibers). More specifically, as used herein the term “hinge” describes the perpendicular distance from the outermost surface of the colored coating of the extreme fibers to the respective outermost portion of the width of the ribbon (measured along the baseline). Accordingly, the ribbon slot must be machined to a depth that considers not only the desired fiber counts in the respective fiber ribbon sub-units but also the hinge, which is typically between about 30 and 60 microns. The thickness of the hinge (e.g., 40 microns) is relatively small compared to the diameter of a typical optical fiber (e.g., 240 microns).

As the required tolerance for a successful subdivision is extremely small, the ribbon-splitting tool according to the present invention must be precisely formed to comport with the particular dimensions of a particular optical fiber ribbon.

Those having ordinary skill in the art will appreciate that larger ribbons (whether mono-unit or multi-unit) may be subdivided into smaller ribbons in virtually any integer combination. For an exemplary ribbon-splitting tool, a ribbon slot having a depth equivalent to 24 fibers (and hinge, if required) would be capable of separating a 36-fiber ribbon into a 24-fiber ribbon sub-unit and a 12-fiber ribbon sub-unit.

Likewise, a ribbon slot having a depth equivalent to 12 fibers (and hinge, if required) would be capable of separating a 24-fiber ribbon into two 12-fiber ribbon sub-units (as well as a 36-fiber ribbon into a 12-fiber ribbon and a 24-fiber ribbon).

Furthermore, a ribbon slot having a depth equivalent to six fibers (and hinge, if required) would be capable of separating a 12-fiber ribbon into two 6-fiber ribbon sub-units, and a ribbon slot having a depth equivalent to four fibers (and hinge, if required) would be capable of separating a 12-fiber ribbon into a 4-fiber ribbon sub-unit and an 8-fiber ribbon sub-unit.

As noted, multi-unit fiber ribbons are formed by joining smaller mono-unit fiber ribbons. In accordance with the foregoing, the ribbon-splitting tool according to the present invention can be configured to accommodate the separation of such fused ribbons into their constituent components.

In the specification and figures, typical embodiments of the invention have been disclosed. The present invention is not limited to such exemplary embodiments. The figures are schematic representations and are not necessarily drawn to scale. Unless otherwise noted, specific terms have been used in a generic and descriptive sense and not for purposes of limitation.

1. A tool for splitting an optical fiber ribbon, the tool comprising:
a tool housing defining a planar section and a substantially uniform, longitudinal ribbon slot formed in said planar section of said tool housing;
wherein the ribbon slot has a specific depth and width to receive and seat a discrete portion of a vertically oriented optical fiber ribbon.

2. A tool according to claim 1, wherein said tool housing defines two or more substantially uniform, longitudinal ribbon slots of different depths, the ribbon slots being formed in said planar section of said tool housing.

3. A tool according to claim 1, wherein said tool housing defines a plurality of planar sections and a plurality of substantially uniform, longitudinal ribbon slots formed therein;
wherein the plurality of substantially uniform, longitudinal ribbon slots define two or more distinct ribbon slot depths; and
wherein at least two planar sections of said tool housing include one or more longitudinal ribbon slots.

4. A tool according to claim 1, wherein the width of the ribbon slot conforms to the cross-sectional height of the optical fiber ribbon.

5. A tool according to claim 1, wherein said tool housing defines a longitudinal ribbon slot having a depth that is greater than about two times (2×) the average fiber diameter possessed by the optical fiber ribbon.

6. A tool according to claim 1, wherein said tool housing comprises metal.

7. A tool according to claim 1, wherein said tool housing comprises anodized metal.

8. A tool according to claim 1, wherein said tool housing comprises stainless steel.

9. A method of making the tool according to claim 1, comprising the step of forming a substantially uniform, longitudinal ribbon slot in a planar section of a tool housing, the ribbon slot having a specific depth and width to facilitate the seating of a discrete portion of a vertically oriented optical fiber ribbon.

10. A method according to claim 9, wherein the substantially uniform, longitudinal ribbon slot is formed via an electrical discharge machine.

11. An optical-fiber-ribbon-splitting tool, consisting essentially of a tool housing, said tool housing defining one or more planar sections and one or more ribbon slots, wherein at least one ribbon slot is formed in at least one planar section, the at least one ribbon slot being capable of receiving and seating a vertically oriented optical fiber ribbon.

12. A method of using a tool for splitting an optical fiber ribbon, comprising:
providing a tool housing that defines a planar section and a substantially uniform, longitudinal ribbon slot formed in the planar section of the tool housing, the ribbon slot having a specific depth and width to receive and seat a discrete portion of a vertically oriented optical fiber ribbon;
vertically positioning a first portion of the optical fiber ribbon in the ribbon slot such that a first portion of the optical fiber ribbon is seated along the length of the ribbon slot and a second portion of the optical fiber ribbon is unseated; and
applying sufficient force to the second portion of the optical fiber ribbon to cause the optical fiber ribbon to bend and thereby split the optical fiber ribbon.

13. A method according to claim 12, wherein the step of applying force to the second portion of the optical fiber ribbon causes the optical fiber ribbon to split along its length to yield a first fiber ribbon sub-unit and a second fiber ribbon sub-unit, the first fiber ribbon sub-unit substantially conforming to the first portion of the optical fiber ribbon and the second fiber ribbon sub-unit substantially conforming to the second portion of the optical fiber ribbon.

14. A method according to claim 12, wherein the first seated portion of the optical fiber ribbon comprises at least two fibers.

15. A method according to claim 12, wherein the second unseated portion of the optical fiber ribbon comprises at least four fibers.
